(19) United States
(12) Patent Application Publication
(10) Pub. No.: US 2013/0238145 A1
(43) Pub. Date: Sep. 12, 2013

(54) SENSOR SYSTEM

(71) Applicants: Yair Hammer, Shoham (IL); Moshe Klein, Elad (IL)

(72) Inventors: Yair Hammer, Shoham (IL); Moshe Klein, Elad (IL)

(73) Assignee: HIGH CHECK CONTROL LTD, SHOHAM (IL)

(21) Appl. No.: 13/885,711

(22) PCT Filed: Nov. 17, 2011
(86) PCT No.: PCT/IL11/00896

§ 371 Date: May 16, 2013

(30) Foreign Application Priority Data
Nov. 17, 2010 (IL) 209390

(51) Int. Cl. G05D 3/00

(52) U.S. Cl. CPC G05D 3/00
USPC 700/279

(57) ABSTRACT

A sensor module including a plurality of sensors for measuring a variety of parameters of a substance and a controller for controlling the operations of the sensor module and the sensors, as well as a sensor system including the sensor module and means for moving the sensor module through the substance, where the sensor module controller is also coupled to and controls the means for moving.

### FIELD OF THE INVENTION

The present invention relates to a sensor system, in general and, in particular, to a sensor system for liquid and gas tanks, reservoirs and pools.

### BACKGROUND OF THE INVENTION

Processes carried out in tanks, reservoirs or pools of fluid are not well monitored, resulting in misprocessing and loss of revenue. At present, processes and storage require a lot of manual sampling. Many processes are not repeatable, causing a wide variety of end results and poor quality products.

Conventional sensors typically provide fixed location measurement of a single parameter, while sensors capable of measuring more than one parameter are often stationary and are typically very expensive. In addition, many conventional sensors require side drilling, cable routing and other costly infrastructure.

### SUMMARY OF THE INVENTION

The present invention relates to a sensor system for a container of a liquid, gas or flexible solid substance including a sensor module that can be moved to a variety of different locations within the container, permitting control of the sensor module from within the sensor module.

There is provided according to the present invention a sensor module including a plurality of sensors for measuring a variety of parameters of a substance and a controller in the sensor module for controlling location and operation of the sensor module and operation of the sensors.

According to some embodiments of the invention, the sensor module further includes a sensor module processor for processing data received from the plurality of sensors according to preset requirements, the controller being coupled to the sensor module processor and including a processor for receiving processed data from the sensor module processor and controlling the sensor module in accordance therewith.

There is also provided, according to the invention, a sensor system including a sensor module including a plurality of sensors for measuring a variety of parameters of a substance, apparatus for moving the sensor module through the substance, and a sensor module controller mounted in the sensor module and coupled to the apparatus for moving and to the sensors for controlling operation of the means for moving and of the plurality of sensors.

According to some embodiments, the sensor system further includes a processor for processing data received from the plurality of sensors according to preset requirements.

There is further provided, according to the invention, a method for monitoring a substance in a tank, the method including mounting on the tank a sensor module including: a. a plurality of sensors for measuring a variety of parameters of a substance; and b. a controller in the sensor module for controlling location and operation of the sensor module and operation of the sensors, coupling to the sensor module apparatus for moving the sensor module through the tank, and actuating the sensors by means of the controller.

According to some embodiments, the method further includes processing the measured parameters in a processor and utilizing the processed data for controlling operation of the sensor module.

### BRIEF DESCRIPTION OF THE DRAWINGS

The present invention will be further understood and appreciated from the following detailed description taken in conjunction with the drawings in which:

FIG. 1 is a schematic illustration of a tank having a sensor system constructed and operative in accordance with one embodiment of the present invention;

FIG. 2 is a schematic illustration of a reservoir having a sensor system constructed and operative in accordance with one embodiment of the present invention;

FIG. 3 is a schematic illustration of a sensor module constructed and operative in accordance with one embodiment of the present invention;

FIG. 4 is a perspective front view of a external control unit constructed and operative in accordance with one embodiment of the present invention;

FIG. 5 is a perspective rear view of the external control unit of FIG. 4;

FIG. 6 is a flow chart illustration of the operation of a sensor system in accordance with one embodiment of the present invention; and

FIG. 7 is a perspective view of a sensor system constructed and operative in accordance with another embodiment of the present invention.

### DETAILED DESCRIPTION OF THE INVENTION

The present invention relates to a sensor module, and a sensor system including such a sensor module, for monitoring a plurality of parameters of a substance. The substance may be a liquid, a gas, or a solid, particularly a flexible powdered or granulated solid, etc. The sensor module includes a plurality of sensors for measuring a variety of parameters of the substance, and preferably a processor for processing data received from the sensors It is a particular feature of the present invention that the sensor module further includes an internal controller for controlling the sensor module, either according to a pre-programmed set of instructions or utilizing detected data from the sensors or processed data from the processor for controlling the sensor module. For example, the internal controller may control the duration and location of operation of the various sensors in the module, and/or the power consumption of the sensor module, etc. Preferably, the controller is capable of self-learning.

The sensor module is coupled to means for moving the sensor module vertically and/or horizontally. For example, the sensor module can be arranged to travel along one or more vertical or horizontal cables (preferably non-conductive), as by means of a mechanical system, such as a pulley with a motor. In this way, for example, when the sensor module is used inside a liquid tank, various parameters can be measured at different depths inside the tank, or at different locations along the tank in the horizontal plane. Alternatively, the sensor module may be mounted on a crane arranged to move the module from place to place, for example inside the water of a sea port, or inside an aeration basin in a waste water treatment plant.

The operation of the pulley moving the sensor module preferably is controlled by the internal controller in the sensor module, in accordance with preset rules, and/or in accordance with the data received from the sensors. For example, the sensor module may be programmed to take temperature measurements in three different locations once a day. In the event that the temperature measured in one location is substantially lower than the temperature measured in the other locations, the sensor module may be configured to immediately measure the temperature again in that location.

An encoder, or other feedback means, may be coupled to the mechanical system to indicate or permit calculation of the distance traveled by the sensor module to its present location, so that the controller can determine at all times where the sensor module is located.

The sensor module further includes communication means, such as a transceiver, for transferring the measurements collected by the various sensors to a remote location, whether wireless or over wires.

The sensor module may include a large variety of sensors, depending on the substance to be monitored. For example, when the substance is a liquid, the module may include sensors for performing liquid level measurements, for measuring temperature, pressure, dissolved oxygen, vapor pressure, pH, ammonia concentration, turbidity, or any other customer required measurement. This way, a single sensor module is able to perform various measurements.

Processing of the data from the sensors is carried out according to preset requirements, such as average reads from the sensor, noise elimination, etc.

Preferably, the sensor module includes an internal energy source that is self-maintained and long lasting. According to one embodiment, the energy source is automatically recharged externally by induction, as described in detail below.

According to one embodiment, an external control unit is provided, that can be permanently mounted inside or outside of the tank. The external control unit may be configured for receiving data from the sensor module and for processing of the data, for example, calculating tank liquid volume, liquid density, tank mass, dissolved oxygen levels, and/or any other desired parameters based on the received data. The sensor module communicates with the external control unit, preferably, via a wireless communication channel, such as a radio channel, an acoustic channel or an optical channel. The external control unit includes wireless or wired communication devices, for receiving data from the sensor module and for transferring relevant parameters to another external location or device.

The data collected by the different sensors may be stored and processed by the sensor module and then transferred to the external control unit. Preferably, the sensor module processes the data and transmits a data profile, reflecting the substance parameters. The profile may be a combination of different parameters taken in one location inside the tank, a weighting of parameters from different locations, or parameters taken over time, etc.

The sensor module can be arranged to automatically rise above the liquid level before transmitting collected data to a remote location. The sensor module may further be coupled to an antenna extending above the liquid level, allowing the sensor module to transmit the data even when immersed in the liquid. Alternatively, transmitting the data can be carried out through wires.

According to some embodiments, the external control unit can dictate the location of measurement and the parameters to be measured by the sensor module. For example, the control unit can request measurement of pressure at a specific time at a specific location. These instructions can be transferred to the controller of the sensor module by any two-way communication arrangement between the control unit and the sensor module.

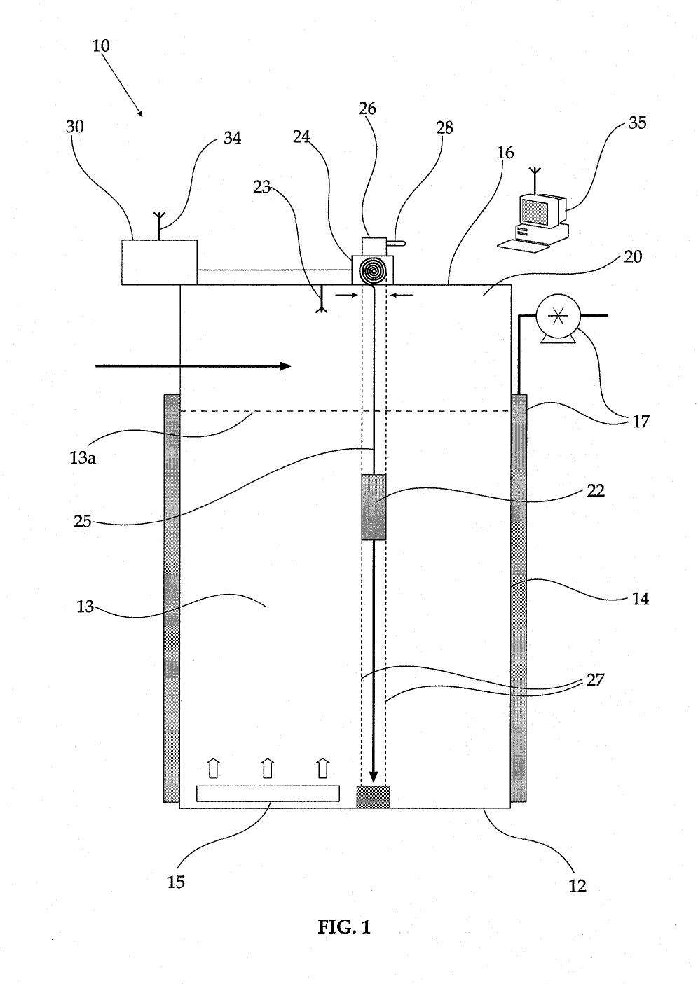

FIG. 1 is a schematic illustration of a tank 10 with a sensor system having a sensor module 22, constructed and operative in accordance with one embodiment of the present invention, mounted thereon. Tank 10 may be any substance container, for example, a conventional freestanding tank, vessel tank, tanker, tank truck, or may be part of an integral part of a construction or a tank buried in the ground, etc. Tank 10 includes a bottom wall 12 coupled to side walls 14. According to the embodiment of FIG. 1, a top wall 16 is provided, as well. Tank 10 contains a substance, here illustrated as a liquid 13, such as water, wine, milk, etc, which reaches a liquid level 13a inside tank 10. Alternatively, as stated above, the contents of tank 10 can be a suspension or semi-solid, a gas or solid. In addition, bottom wall 12 and/or side walls 14 may be coupled to a cooling or heating system 17 for obtaining and maintaining a desired temperature inside tank 10.

If desired, tank 10 may further include a stirring system 15 for circulating liquid 13, or any other substance, inside tank 10, thereby ensuring the homogenous texture of liquid 13. Stirring system 15 may be, for example, a blender inside tank 10, or blowers or any other mixing means configured for creating turbulence inside tank 10, as known.

Sensor module 22 includes a plurality of sensors and detectors, for example, an absolute pressure sensor, a temperature sensor, a pH sensor, a dissolved oxygen sensor, etc. The provision of a plurality of sensors in a single sensor module increases the cost effectiveness and reduces the size of the system. It will be appreciated that the contents of the sensor module may be customized in accordance with the requirements of each particular application.

The sensor system further includes means for moving sensor module 22, here illustrated as a pulley 24 and motor 26 coupled to top wall 16 of tank 10. If tank 10 does not include a top wall 16, a rod may be horizontally mounted over tank 10 for holding pulley 24 and motor 26. A first end of a cable 25 is coupled to pulley 24, and a second end of cable 25 is coupled to sensor module 22. Preferably, the length of cable 25 permits pulley 24 to raise or lower sensor module 22 up and down along the entire height of tank 10, so that sensor module 22 acts as a plummet. Preferably, cable 25 is formed of non-conductive wire, so as to preclude deterioration of the cable caused by chemical reactions of certain chemicals in liquid 13, such as solvents, etc. A motor 26, preferably a precise motor, such as a servomotor, a stepper or others, is drivingly coupled to pulley 24. Motor 26 preferably includes an encoder 28 mounted on the motor shaft for calculating the position of sensor module 22 within tank 10, e.g., by counting the number of rotations of motor 26, as known in the art. Encoder 28 may, alternatively, be mounted on any other moving part, such as pulley 24 or cable 25, or may be configured to measure the movement of sensor module 22 relative to the top of tank 10.

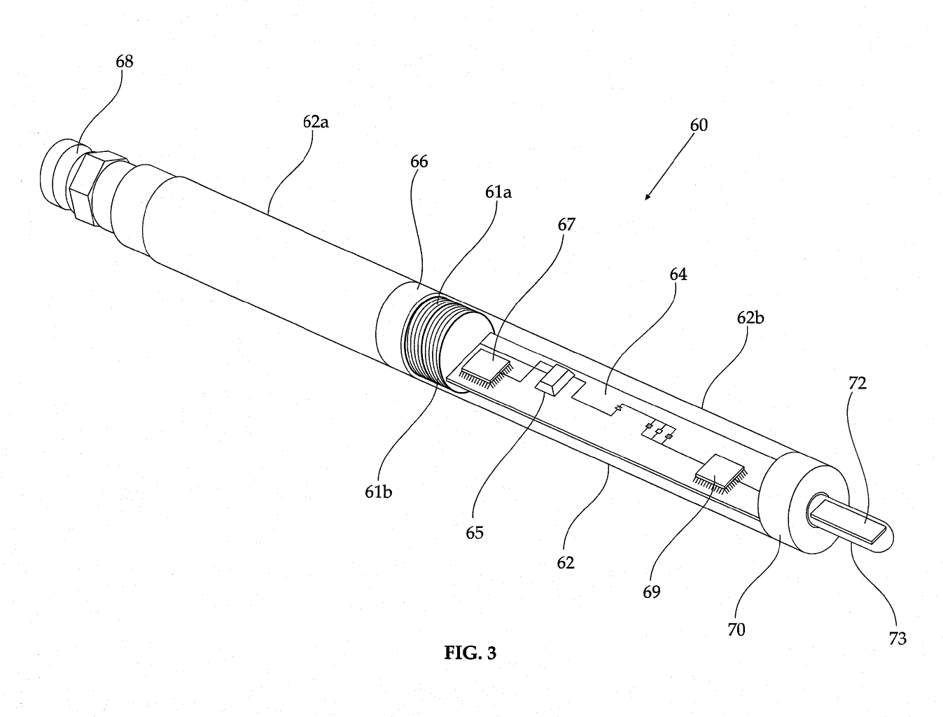

Sensor module 22 further includes a controller, shown in detail in FIG. 3, for controlling movement and operation of sensor module 22. The controller controls the operation of the sensors, for example, the kind and the frequency of measurements taken by each sensor. In addition, the controller controls the means for moving the sensor module, thereby setting the desired position of the sensor module, and the location in tank 10 from which the measurements are taken. It will be appreciated that in order to permit sensor module 22 to control its own movement, motor 26 must be coupled to the controller of sensor module 22. This control can be implemented by wired or wireless communication, as known, or in any other desired fashion. According to some embodiments, the controller is arranged to activate a device outside the reservoir.

Tank 10 may further include one or more guides 27 mounted beneath pulley 24, along the height of tank 10 for guiding sensor module 22 in a vertical direction. Guides 27 substantially prevent sensor module 22 from moving inadvertently in the horizontal direction, thereby retaining the straight trajectory of sensor module 22. Guides 27 are especially useful when tank 10 contains a turbulent liquid, because precluding horizontal displacement of sensor module 22 is necessary to ensure the vertical position of sensor module 22 while obtaining data of the monitored parameters. Guides 27 may be guide wires, plastic guides, or any other suitable guide elements. Alternatively, or in addition to guides 27, a positioning weight may be provided on or inside sensor module 22, for increasing the gravitational force exerted on sensor module 22. Alternatively, sensor module 22 can be arranged to travel inside a vertical hollow pipe having apertures allowing liquid 13 to penetrate the hollow pipe.

Optionally, a tank top sensor (not shown) may be coupled to tank top wall 16 for providing an indication to sensor module 22 when it reaches the top of tank 10, so as to stop the operation of motor 26. The tank top sensor can be any conventional sensor. For example, sensing the bottommost or topmost position can be carried out by measuring the electric current consumption of motor 26. When the sensor module is blocked by top wall 16 or bottom wall 12 of tank 10, the current consumption of motor 26 increases, thus the position of sensor 22 can be determined. Alternatively, the bottommost or topmost position can be sensed with optical means, such as a photodetector arranged to detect when sensor module 22 passes a certain point along the height of tank 10.

Sensor module 22 may be configured to measure the liquid level 13a inside tank 10. It will be appreciated that determining liquid level 13a can be carried out by using any known method, for example, by detecting the presence of liquid inside tank 10 while lifting sensor module 22 from the bottom of tank 10, upwardly. Once sensor module 22 passes liquid level 13a, the liquid sensor does not detect the presence of liquid 13, and the position of sensor module 22, at that point, can be calculated from encoder 28. Alternatively, determining liquid level 13a can be carried out by detecting the presence of liquid inside tank 10 while lowering sensor module 22 from the top of tank 10, downwardly. As sensor module 22 passes liquid level 13a, the liquid sensor detects the presence of liquid 13, and the position of sensor module 22, at that point, can be calculated from encoder 28. Detecting the presence of liquid 13 can be carried out by sensing pressure, conductivity, pH of the liquid, or any other parameter. Since these parameters, when measured inside liquid 13, are different than when measured outside liquid 13, sensor module 22 receives an indication when passing liquid level 13a, and the measured parameter changes.

Alternatively, liquid level 13a may be determined by comparing the results of pressure measurements at different times at the same height relative to the bottom of tank 10. For example, if the pressure at a certain height is smaller than the pressure previously measured at the same height, a reduction in the liquid level can be deduced. It will be appreciated, in this case, that determining the exact change in the liquid level is carried out using pre-stored information regarding the pressure for each liquid level. This information can be obtained in a calibration process, as known in the art, and may vary in accordance with the kind of liquid stored in the tank.

According to one embodiment, tank 10 is further provided with a external control unit 30 coupled for two-way communication with the controller of sensor module 22. External control unit 30 collects sensed data from sensor module 22, and sends the collected data to a remote location. External control unit 30 may further process the received data, if desired, before sending it to a remote location. External control unit 30 may also be coupled to motor 26, for controlling the movement of sensor module 22. According to some embodiments of the invention, external control unit 30 communicates with sensor module 22 by means of RF communication, as described in detail below. Alternatively, external control unit 30 can communicate with sensor module 22 by means of any wireless or wired communication.

External control unit 30 includes a transceiver for receiving data from sensor module 22, and sending instructions to the various sensors in sensor module 22. In addition, external control unit 30 includes a memory device for storing the collected data received from sensor module 22, and preferably a processor for analyzing the parameters data.

An antenna 23 may be coupled to the transceiver and mounted inside tank 10, for wireless communication between the transceiver, and/or a remote unit 35, and sensor module 22. This can be carried out by any known method, such as Bluetooth, RF, etc. Alternatively, external control unit 30 may include an acoustic transducer for sound wave communication with sensor module 22, or may include a light source and a photo detector for optical communication with sensor module 22. It will be appreciated that sensor module 22 includes communication means corresponding to the communication means of the external control unit 30 and/or to remote unit 35. External control unit 30 may further include an external antenna 34 for communicating with a remote unit 35. Remote unit 35 may receive data from a plurality of external control units and/or sensor modules, each coupled to a tank having a sensor system, and may serve as a remote controller for those units. Alternatively, remote unit 35 may be configured to display data received from a single external control unit and sensor module at the remote location, or it may be an industry standard field-device, providing control means for various actuators (e.g., chilling liquid pumps, gas inlets (N₂, SO₂, or similar), external circulation pumps, etc.). In this way, remote actuators can be activated or deactivated according to the output of sensor module 22. According to some embodiments of the invention, RF communication is carried out is by means of a mesh network.

In order to allow sensor module 22 to output the various parameters at different heights in tank 10, the position of sensor module 22 relative to the height of tank 10 must be determined automatically or manually during initialization of the system. This is carried out by setting a reference position of sensor module 22 and determining the maximum height of tank 10. The position of sensor module 22 can be determined by bringing sensor module 22 to the topmost position in tank 10, and setting this point to be the zero reference point of encoder 28. Once the zero reference point is set, the height of tank 10 can be calculated by lowering sensor module 22 to the bottommost position inside tank 10, and calculating, using encoder 28, the number of rotations of motor 26 required for displacing sensor module 22 from the topmost to the bottommost position. In this way, the range of motion of sensor module 22 in tank 10 is determined. The actual position of sensor module 22 at any time can be calculated by multiplying the pre-stored displacement increment per one motor rotation by the rotation count from encoder 28. Alternatively, setting the zero reference point can be carried out by bringing sensor module 22 to the bottommost position of tank 10. In this case, obtaining the height of tank 10 is carried out by pulling sensor module 22 to its topmost position and by counting the number of required rotations of motor 26. Alternatively, the height of tank 10 may be manually input to the controller and/or to the external control unit 30 or it may be obtained by any other known method.

According to yet another embodiment, setting the zero reference point is carried out by utilizing a cable tension sensor. When the sensor module 22 is lowered to the bottom of tank 10 and rests on bottom wall 12, the tension of cable 25 is reduced. Alternatively, setting the zero reference point may be carried out by measuring motor electric current. For example, when sensor module 22 is lowered to the bottom of tank 10 and rests on bottom wall 12, the electric current of the motor is reduced. This way, the zero reference point can be set when sensor module 22 is at the bottommost position inside tank 10.

After calculating the height of tank 10 or inputting it manually, the controller in the sensor module or the external control unit 30 can calculate the current position of sensor module 22 relative to the height of tank 10. This is carried out by counting the number of rotations of motor 26 required for displacing sensor module 22 from the preset zero reference point to its current position, and multiplying the number or rotation by the pre-stored displacement increment per rotation. The rotations may be counted by encoder 28, as known in the art. It will be appreciated that, in order to calculate the exact location of sensor module 22, encoder 28 must take into consideration the direction of rotation of motor 26. For example, if sensor module 22 is lowered down by a clockwise rotation of motor 26, and is lifted up by a counterclockwise rotation, encoder 28 translates one clockwise rotation as one downward displacement increment. Similarly, one counterclockwise rotation is translated as one upward displacement increment. This way, external control unit 30 and/or sensor module 22 can keep track of the exact position of sensor module 22 at any given time relative to the height of tank 10.

Preferably, the sensor system is initialized, by resetting the zero reference point and measuring the maximum height of tank 10, when the sensor system is restarted or when the output data is suspected to be erroneous.

During the initialization process of sensor system 20, initialization data from sensor module 22 may be sent to external control unit 30. The initialization data includes data related to the sensors integrated in sensor module 22, for example, the number and kinds of sensors. The initialization data may include reference parameters for each sensor for comparison with the measured parameters, for example, the data output from the various sensors in sensor module 22, when positioned outside of the substance being monitored. These parameters' reference data can be stored in sensor module 22 and/or in external control unit 30 and can be used to compare with parameter data output from these sensors when positioned within the substance in different positions along the height of tank 10. In addition, the initialization data may include identification data of the sensor module, such as a serial number, allowing external control unit 30 to send the data, received from sensor module 22, along with the identification data, to a remote location. This is particularly important when the remote location receives data from more than one sensor module.

Preferably, external control unit 30 is coupled to sensors mounted inside tank 10, which can be used for performing self-calibration of sensor module 22. For example, external control unit 30 may include a pressure sensor (not shown) mounted inside tank 10 in addition to the pressure sensor mounted inside sensor module 22. Sensor module 22 can be calibrated by comparing the parameters measured by the pressure sensor mounted inside sensor module 22, with the parameters measured by the pressure sensor coupled to external control unit 30.

Typically, the sensor module performs measurements in a series of cycles. At the start of a cycle, sensor module 22 typically is held fully or partially above the surface of the substance being monitored. Periodically, motor 26 is activated and pulley 24 lowers sensor module 22 toward the bottom of tank 10 for a measurement cycle. A measurement cycle may include measuring of one or more parameters using one or more sensors in sensor module 22. The measured parameters may include, for example, liquid level, absolute liquid pressure levels, liquid temperature, pH level, conductivity, percentage of dissolved oxygen, or other parameters, as required.

The depth at which the measurements are taken can be dictated by the controller inside sensor module 22 or, alternatively, by external control unit 30, and can vary from cycle to cycle, in accordance with various requirements. Preferably, each cycle includes measuring parameters at more than one position, so as to provide external control unit 30 with comprehensive data regarding the substance inside the entire tank 10. Controlling the depth at which sensor module 22 is positioned is carried out by directing the operation of the means for moving the sensor module, e.g., pulley 24, cable 25, and motor 26, and by calculating the displacement of cable 25 per each rotation of motor 26, as described above.

It is a particular feature of the present invention that sensor module 22 can control its own operation. In other words, the action of the sensor module 22 can be changed according to the results of previous measurements received from the sensors. For example, suppose the sensor module is configured to send an alert when the temperature inside the tank drops below a predefined threshold. If the measured temperature inside the tank continues to drop below a second predefined threshold, or is otherwise abnormal, the sensor module may change its mode of operation and take another set of measurements, or activate a heater, or perform another pre-selected action. The internal controller and/or the external control unit preferably are programmed to take into consideration all of these parameters, before selecting the next action of the sensor module.

In order to allow transmission of the sensor readings to external control unit 30, following the measurement cycle, at least a portion of sensor module 22 may be lifted above liquid level 13a. This is particularly helpful when the communication between sensor module 22 and external control unit 30 is wireless.

In case a stirring system 15 is provided, liquid 13 inside tank 10 may be periodically mixed. Stirring liquid 13 inside tank 10 precludes sinking of some components of liquid 13, thus a more accurate measurement of the desired parameters can be reached by sensor module 22. Preferably, stirring system 15 is coupled to and controlled by external control unit 30, so as to synchronize the operation of sensor module 22 and stirring system 15. For example, external control unit 30 can actuate stirring system 15 before actuating sensor module 22, thereby ensuring more balanced results when measuring parameters of liquid 13. Alternatively, the sensor module can control operation of the stirring system 15.

Remote controller 35 may be coupled to a plurality of sensor systems 20, each mounted on a tank or a pool. The data received from sensor systems 20 may be analyzed by remote controller 35, comparing parameters of substances in different tanks. For example, remote controller 35 may be coupled to a plurality of sensor systems 20 mounted on wine barrels storing wine. The sensor systems can measure the temperature, pH level, wine density, etc. The sensor module 22 and external controller 30, in this case, operate in the same fashion as described above. Remote controller 35 can compare the parameters of each wine barrel, so as to allow the winemaker to make a better decision, for example, regarding the wine aging process.

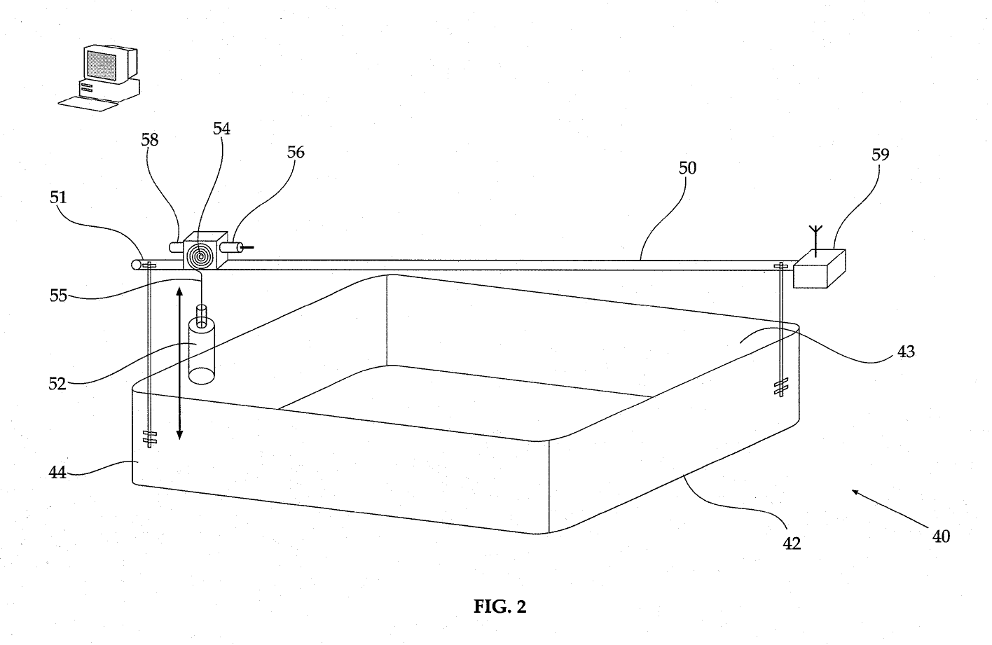

FIG. 2 is a schematic illustration of a substance reservoir 40 having a sensor system 50, constructed and operative in accordance with another embodiment of the present invention. According to this embodiment, sensor system 50 includes means for moving a sensor module in the horizontal direction as well as in the vertical direction, so as to allow measurement of parameters in various locations along the width or the length of reservoir 40, as well as along its height. Reservoir 40 includes a bottom wall 42 coupled to side walls 44, here illustrated as defining a quadrangular reservoir, adapted for containing substance 43. Reservoir 40 may be, for example, a water reservoir, such as a well, an aquarium, a pond, an aeration basin, a gravity sludge thickener, a waste water treatment pool, a disinfection pool or any other reservoir, containing fluids or any other substance.

The means for moving in sensor system 50 includes a rod 51 mounted above reservoir 40, for carrying a horizontally moving pulley 54. Pulley 54 may be substantially the same as pulley 24 of FIG. 1, and includes a cable 55 for holding a sensor module 52. Pulley 54 and cable 55 permit conveying sensor module 52 up and down along the height of reservoir 40. According to this embodiment, pulley 54 can slide longitudinally along rod 51, so as to allow lowering sensor module 52 into liquid 43 when the sensor module is located at a desired spot along the length of rod 51. This way, measurements of parameters of substance 43 can be taken in various horizontal locations along reservoir 40, as well as at different depths. Sliding pulley 54 along rod 51 can be carried out using an additional cable and pulley (not shown), or in any other fashion.

Pulley 54 is coupled to a motor 56, and to an encoder 58 for calculating the position of sensor module 52 relative to the height of reservoir 40, and its position relative to the side walls of reservoir 40, as by counting the number of rotations of motor 26, as known in the art.

Preferably, sensor system 50 further includes an external control unit 59, operative in substantially the same fashion as external control unit 30 of FIG. 1. Sensor module 52 and external control unit 59 operate and interact in any of the manners described above with regard to FIG. 1. Furthermore, measurements may be performed in cycles through a horizontal plane, in the same way as described with regard to depth of the sensor module.

It will be appreciated that rod 51, mounted over reservoir 40, may be arranged to be positioned anywhere along the length or the width of reservoir 40, and arranged to position the sensor module along a portion of the length or the width, or over any desired portions of reservoir 40. Alternatively, rod 51 may be replaced with a track having any desired shape, for example, a rectangle or a circle. The track can be mounted over reservoir 40 and sensor module 52 can be conveyed along the track so as to take measurements at any point underneath the track.

According to yet another embodiment, sensor module 52 is mounted on a crane, which is mounted above reservoir 40. The crane is configured to carry sensor module 52 to any location above reservoir 40, where sensor module 52 can be lowered into substance 43, inside reservoir 40.

FIG. 3 is a perspective illustration of a sensor module 60 constructed and operative in accordance with one embodiment of the present invention. Sensor module 60 can operate and interact in any fashion described with regard to sensor module 22 of FIGS. 1 and 2. Sensor module 60 includes a waterproof housing 62, to permit immersion of sensor module 60 in liquid without damaging the electronic components encased therein. Preferably, sensor module 60 includes a first portion 62a, and a second portion 62b. First portion 62a includes a plurality of sensors, for example, a temperature sensor 66, and an absolute pressure sensor 68. Second portion 62b includes the power source 70, and an electric circuit 64 having a processing unit and a memory device, for processing and storing the data received from the sensors in portion 62a. Second portion 62b further includes a transceiver 72, such as an RF transceiver, acoustic transceiver, optic transceiver, etc.

Thus, first portion 62a is dedicated for housing the sensors and data acquisition, and second portion 62b is dedicated for power supply, data processing, and communication. First and second portions 62a and 62b are designed for coupling to one another to form the complete sensor module. Dividing sensor module 60 in such a way provides configuration flexibility, and allows exchanging first portions in accordance with the customer's requirements. For example, in case a temperature sensor is required, a first portion having a temperature sensor may be coupled to a second portion. And, in case a pH sensor is required, the first portion can be replaced with a first portion having a pH sensor, without having to replace second portion 62b. Similarly, in case dissolved oxygen, temperature and pressure sensors are required, the first portion can be replaced with a first portion having dissolved oxygen, temperature and pressure sensors, without having to replace second portion 62b. This arrangement allows manufacturing of second portions of a single arrangement configured to be coupled to a variety of first portions, each having a specific combination of sensors and a respective electric circuit. It will be appreciated that in case the different sensors require a dedicated electric circuit, the electric circuit can be housed inside first portion 62a as opposed to second portion 62b. This way, the sensors and the dedicated electric circuit can be replaced by merely replacing first portion 62a.

In the embodiment illustrated in FIG. 3, coupling first and second portions 62a and 62b to one another is accomplished by screwing a screw thread 61a defined on the inner surface of first portion 62a to a complementary screw thread 61b defined on the outer surface of second portion 62b. The screw thread is configured to provide a waterproof coupling, for example by utilizing a seal (not shown). Alternatively, coupling first and second portions 62a and 62b to one another may be carried out by a snap fit arrangement provided in housing 62, or by any other coupling arrangement which provides a secure sealed coupling. Alternatively, sensor system 60 may include a single housing encasing the sensors, electric circuit and power supply and all the other components. Operation of each of these embodiments is as described above with regard to FIGS. 1 and 2.

Preferably, sensor module 60 includes a pressure sensor with high gain and offset calibration. In addition, sensor module 60 includes a high accuracy temperature sensor. Sensor module also includes an internal processor unit 67. Processor unit 67 may be a low power processor which allows real time control and data acquisition capabilities.

A power source 70, mounted inside second portion 62b, is preferably a high capacity rechargeable cell having a cell double protection and charge control ICS with double temperature monitoring for precluding overheating of the power source. In addition, power source 70 may be coupled to a cell fuel gauge for indicating the available power of power source 70.

It is a particular feature of certain embodiments of the invention, that power source 70 includes a charging unit, for example, a charging coil (not shown), for inductive charging through a corresponding charging terminal mounted on top of the tank. An induction coil in the charging terminal on the tank creates an alternating electromagnetic field from within the charging terminal. The charging coil (a second induction coil) in the sensor module takes power from the electromagnetic field and converts it into electrical current to charge the battery inside the sensor module. Alternatively, the sensor module may include another conductor configured for electromagnetic inductive charging. In this way, power source 70 can be charged merely by lifting the sensor module toward the corresponding charging terminal, without the need to couple sensor module 60 to an electric outlet. It is a particular feature of the present invention that controlling the recharging process may be carried out by the internal controller inside the sensor module. The controller can determine when recharging of the battery is required, and can signal the pulley or the crane on which the sensor module is mounted to lift the sensor module to recharge power source 70. Power source 70 with an inductive charging unit can be utilized in any of the sensor modules described herein.

Electric circuit 64 is coupled to power source 70, and includes a memory device 65 for storing the data collected by sensors 66 and 68, and other optional sensors. Electric circuit 64 includes a controller 69 for controlling the operation of the module and an optional separate processing unit 67 for processing the data received from the sensors. It is a particular feature of the present invention that controller 69 controls the operation of sensors 66 and 68, processing unit 67, and the means for moving the sensor module. Transceiver 72, which includes an antenna 73, is coupled to electric circuit 64 and allows for transmitting data, received from sensors 66 and 68, to a remote location or to an external control unit mounted on the tank or the reservoir, as described above. In addition, transceiver 72 allows the external control unit to remotely control the operation of sensor module 60, as required.

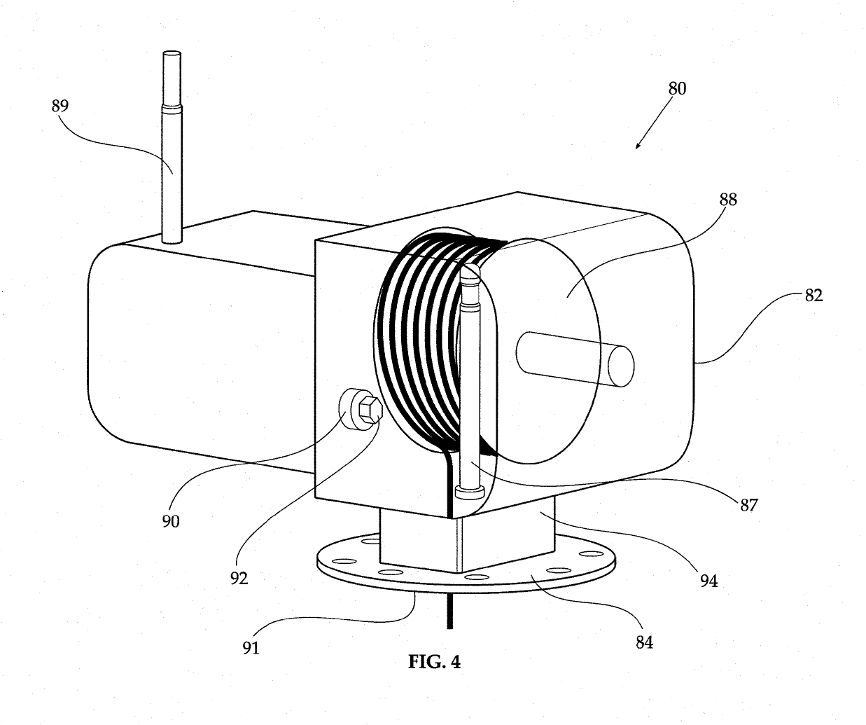

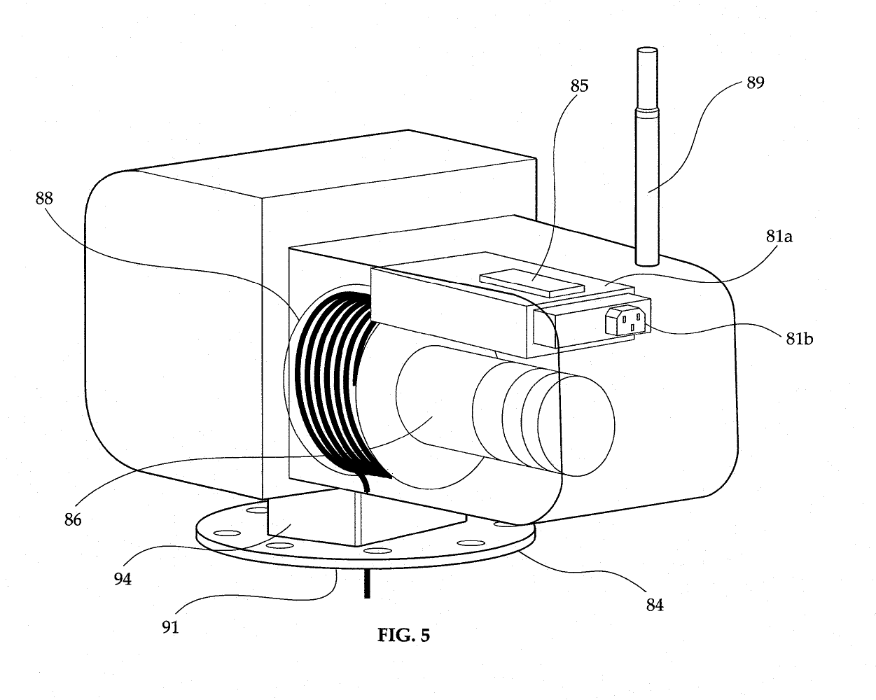

FIGS. 4 and 5 are a perspective front view and a perspective rear view, respectively, of a external control unit 80, constructed and operative in accordance with one embodiment of the present invention. In this embodiment, external control unit 80 is configured for mounting on a top wall of the tank. External control unit 80 includes a housing 82 and mounting elements, here illustrated as a flange 84, for mounting on the top wall of the substance tank or on the side wall of a reservoir, or on a crane mounted above a reservoir. In addition, external control unit 80 includes a controller 85, preferably having a memory device (not shown) for storing data from the sensor module. Controller 85 is coupled to a power source 81a, which can include an electric socket 81b for coupling to the electricity mains, to an electric generator, or to a solar generator. According to this embodiment, a pulley 88 and a motor 86 are integrated in external control unit 80, and are powered by power source 81a. Motor 86 is preferably a precise motor, such as a brushless DC servomotor with controller, a stepper motor, etc.

External control unit 80 may include a pressure sensor 90 (seen in FIG. 4) and a temperature sensor 92 coupled to controller 85. Sensors 90 and 92 can be used to calibrate the sensors on the sensor module, by obtaining measurements and comparing the results with measurements taken by similar sensors mounted on the sensor module, for example by comparing the results of the temperature sensor on the external controller unit 80 with the results of the temperature sensor on the sensor module. It will be appreciated that, in order to ensure accurate calibration, pressure sensor 90 and temperature sensor 92 should preferably be mounted in close proximity to the sensor module. Thus, according to the illustrated embodiment, the calibration process is carried out when the sensor module is elevated to the upmost position next to external control unit 80. It will be further appreciated that the external control unit may be provided with software for controlling the calibration process, or other functions of the sensor system.

In addition, external control unit 80 includes a transceiver (not shown) coupled to controller 85, and an antenna 87 coupled to the transceiver for wirelessly communicating with the sensor module. External control unit 80 may further include an external antenna 89 coupled to controller 85 for wirelessly communicating with a remote controller, such as a central computer receiving data from a plurality of external control units, or with one or more remotely located field devices, each coupled to a tank having a sensor system. Alternatively, external control unit 80 may be connected with wires to a remote controller.

Flange 84 includes a plurality of bolt apertures for mounting external control unit 80 to the tank. Preferably, flange 84 further includes a charging docking station 94, for charging the sensor module. Flange 84 is mounted beneath pulley 88, so as to allow sensor module to abut charging docking station 94, when pulled upwardly by the cable of pulley 88. According to one embodiment, cable 91 hangs down from pulley 88 toward the inside of the liquid tank, through a through-going bore defined inside flange 84. Alternatively, cable 91 may hang down toward the liquid tank, through an aperture in the tank, defined adjacent flange 84, in such a way, which allows docking the sensor module to charging docking station 94. Preferably, charging docking station 94 includes a coil configured for inductive coupling with a corresponding coil in the sensor module, as described above. This way, the sensor module can be charged by merely bringing it close to charging docking station 94. It will be appreciated that charging docking station 94 and the sensor module may, alternatively, include other electronic components configured for inductive charging.

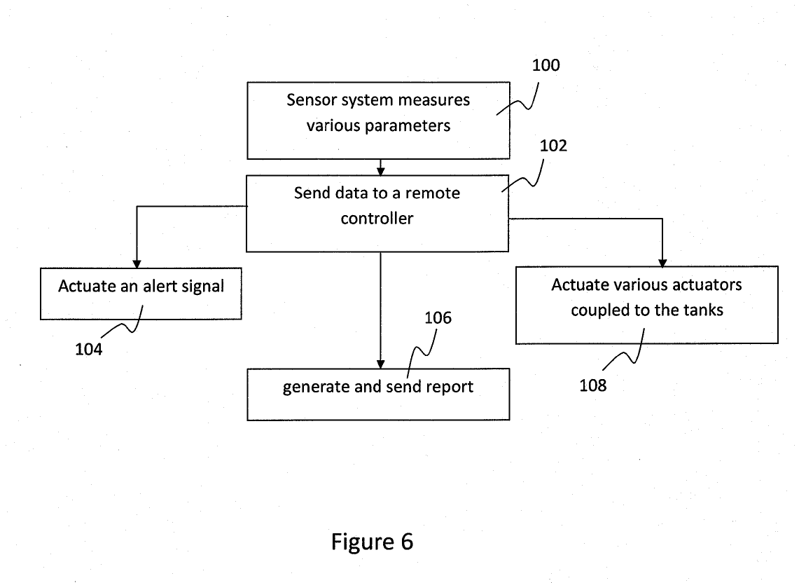

FIG. 6 is a flow chart illustrating operation of a sensor system and a remote controller, in accordance with one embodiment of the present invention. The sensor system, which may be mounted on a substance tank, periodically measures various parameters, preferably in different locations in the tank (block 100). The measured parameter data is sent to a remote controller (block 102), preferably, via a wireless network, such as a cellular network. The remote controller may be connected to the Internet, allowing the user to access the data via the Internet. The remote controller may be configured for actuating an alert signal, such as an alarm, sending a text message, or an email to a supervisor (block 104), for example, when the data received by the remote controller shows that the substance inside the tanks requires the attention of a supervisor. Alternatively, or in addition to the alert signal, the remote controller may be configured for generating reports and analyses from the data received from one or more sensor systems, for example, an inventory report, quality assurance analysis, etc. (block 106). These reports and analyses may be further sent to a user, for example via email, or sent to an inventory database. According to one embodiment, the remote controller may be configured for actuating various actuators coupled to the tanks (block 108), for example, to open a water inlet, close a gas outlet, insert certain materials inside the tank, prompt the sensor system to perform additional measurements inside the tank, etc. Any of these controllers described herein can be utilized with any of the described sensor modules.

As described above, the sensor module according to the invention can provide substantially any measurements desired. Preferably, the module has some or all of the following capabilities:

Real time liquid level measurement, real time temperature measurement, liquid density that can be translated to specific gravity, Brix and liquid stratification, preferably at a resolution defined by the customer. The measurements can be taken at any location from the bottom to the top of the tank, or in different horizontal locations in a reservoir. In addition, the sensor module can detect leaks in the reservoir, for example, by measuring changes in the substance volume, or the substance level, over a given time period.

Furthermore, the sensor module can provide additional parameters, such as: tank liquid volume, tank mass, vapor pressure at the tank top, vapor temperature, liquid viscosity, pH, dissolved oxygen, turbidity, etc.

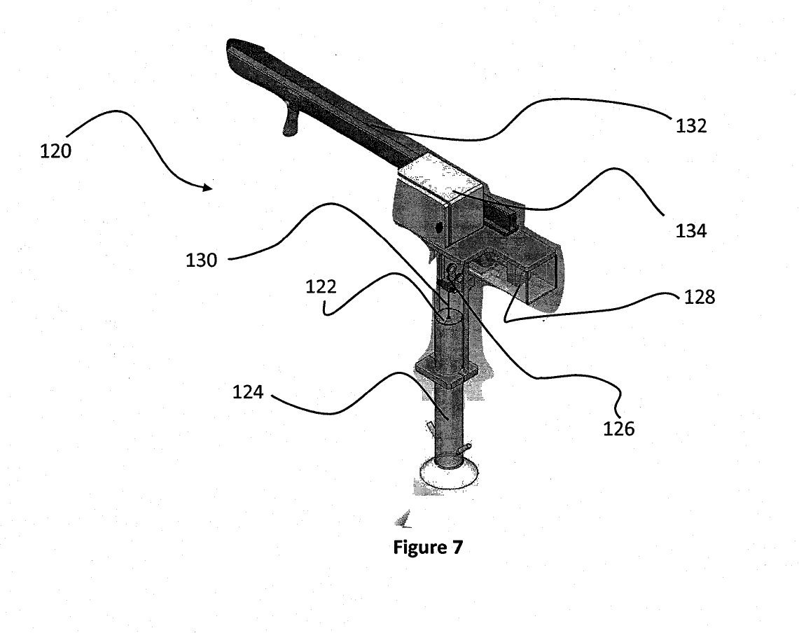

FIG. 7 is a perspective view of a sensor system 120 constructed and operative in accordance with another embodiment of the present invention. According to this embodiment, a sensor module 122 moves up and down inside a sleeve 124 disposed inside a tank, particularly for use with solids inside a liquid, for example, a seaweed growing tank, or in a waste purification tank. Sleeve 124 serves as a channel inside the substance, so as to allow sensor module 122 to freely move up and down inside the tank, without becoming entangled in the material in the tank and permitting rinsing of the cable and the sensor module through the sleeve.

Sensor system 120 further includes a pulley 126 coupled to a motor 128, for moving sensor module 122 up and down by means of a cable 130. In addition, a mounting rod 132 is provided, for mounting sensor system 120 to a side wall of a tank or a reservoir. Preferably, sensor system 120 further includes an external control unit 134 for controlling the operation of sensor system 120 together with the internal controller inside sensor module 122, for processing the data received from sensor module 122, and for transmitting the processed data to a remote location. External control unit 134 may be mounted on mounting rod 132 or on any other element in close proximity of the tank or the reservoir. External control unit 134 and sensor module 122 can interact or operate according to any of the options described herein.

It is a particular feature of the invention that it is not limited to the type of substance to be monitored. Thus, it can be utilized for almost any liquid type, such as chemicals, fuels, various types of crude oil, waste water, beverages, wine, etc., with a few adjustments as to materials disposed inside the liquid and parameters to be measured as well as gases, and solids, particularly flexible, powdered or granulated solids. Thus, the sensor system will be constructed so as not to affect the medium measured (i.e., to comply with food standards, fuel safety requirements (ATEX), etc.) Similarly, the system can be customized for particular uses having special requirements, such as grape skins hardening on the top cover during wine fermentation, a foam layer on the liquid created during the process, and so forth.

The sensor module can be removed easily for maintenance or upgrades. It may support cleaning in process (CIP) systems, if required, for example by periodically washing the sensor module or other portion of the sensor system with sprinklers mounted inside the tank. It will be appreciated that tank process control can also be built into the system. For example, the external control unit may include built in PLC (Programmable Logic Controller) capabilities and may include means for controlling the temperature, density, pH and/or other parameters of the liquid inside the tank. Preferably, the sensor system can integrate easily with industry wide sensors and actuators, using accepted standards in the various industries, such as MODbus, ProfiBus, ProfiNet, HART RF mesh, and so on.

While the system described above has been illustrated and described with a single sensor module, if desired the system may include a plurality of sensor modules all taking measurements in the same tank. The sensor modules may be coupled to the same movement means or may have individual means for moving the modules. Preferably, all are coupled to a single external controller, although a plurality of external controllers may also be provided, each associated with different sensor modules.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A sensor module comprising:
a plurality of sensors for measuring a variety of parameters of a substance; and,
a controller for controlling the operations of the sensor module and said sensors.

2. The sensor module according to claim 1, further comprising:
a sensor module processor for processing data received from said plurality of sensors according to preset requirements;
said controller being coupled to said sensor module processor for receiving processed data from said sensor module processor and controlling the sensor module in accordance therewith.

3. The sensor module according to claim 1, further comprising communication means coupled for two way communication with an external control unit for transferring said measured parameters to said external control unit.

4. The sensor module according to claim 1, further comprising a transceiver for transferring said measured parameters to a remote location.

5. (canceled)

6. The sensor module according to claim 1, including:
a first portion holding said plurality of sensors; and
a second portion holding said controller and a power source.

7. The sensor module according to claim 1, further comprising a waterproof housing for encasing said sensors, said processor, said transceiver and said controller.

8. The sensor system according to claim 1, further comprising a power source; wherein said power source includes a rechargeable battery including a charging unit for recharging said battery by induction charging.

9. A sensor system comprising:
a sensor module including a plurality of sensors for measuring a variety of parameters of a substance;
means for moving said sensor module through said substance; and
a sensor module controller mounted in said sensor module and coupled to said means for moving and to said sensors for controlling operation of said means for moving and of said plurality of sensors.

10. The sensor system according to claim 11, further comprising a processor for processing data received from said plurality of sensors according to preset requirements.

11. The sensor system according to claim 9, further comprising a transceiver for transferring said measured parameters to a remote location.

12. The sensor system according to claim 9, further comprising an external control unit coupled for two-way communication to said controller of said sensor module.

13. The sensor system according to claim 9, wherein said means for moving said sensor module includes a vertical cable coupled to a pulley.

14. The sensor system according to claim 9, wherein said means for moving said sensor module includes a horizontal cable coupled to a pulley.

15. The sensor system according to claim 9, wherein said means for moving said sensor module include a crane.

16. The sensor system according to claim 9, further comprising a power source in said sensor module.

17. The sensor system according to claim 16, wherein said power source includes a rechargeable battery and an induction charging unit.

18. The sensor system according to claim 9, further comprising an external control unit coupled to said sensor module controller.

19. A method for forming a sensor module, the method comprising:
providing a plurality of sensors for measuring a variety of parameters of a substance; and
providing a controller for controlling the operations of the sensor module and said sensors.

20. A method for monitoring a substance in a tank, the method comprising:
mounting on the tank a sensor module including:
a. a plurality of sensors for measuring a variety of parameters of a substance; and
b. a controller in the sensor module for controlling location and operation of the sensor module and operation of said sensors;
coupling to said sensor module means for moving said sensor module through said tank; and
controlling said sensor module by means of said controller for receiving data on the substance from said sensor module.

21. The method according to claim 20, further comprising processing said measured parameters in a processor and utilizing said processed data for controlling operation of said sensor module.
